(19) United States
(12) Patent Application Publication
(10) Pub. No.: US 2014/0323677 A1
(43) Pub. Date: Oct. 30, 2014

(54) THERMAL-SHOCK-RESISTANT CURED PRODUCT AND METHOD FOR PRODUCING SAME

(71) Applicants: Akinori Kitamura, Aichi (JP); Naomasa Furuta, Aichi (JP)

(72) Inventors: Akinori Kitamura, Aichi (JP); Naomasa Furuta, Aichi (JP)

(73) Assignee: TOAGOSEI CO., LTD., Tokyo (JP)

(21) Appl. No.: 14/241,565

(22) PCT Filed: Aug. 29, 2012
(86) PCT No.: PCT/JP2012/071773

§ 371 Date: Apr. 4, 2014

(30) Foreign Application Priority Data
Sep. 1, 2011 (JP) 2011-190248

(51) Int. Cl. C08G 77/20

(52) U.S. Cl. CPC C08G 77/20
USPC 528/32

(57) ABSTRACT

The present invention is a method for producing a thermal-shock-resistant cured product, the method involving: a condensation step of preparing a cured-product precursor by subjecting monomers represented by general formulae (1) to (5) to copolycondensation at a specific rate in the presence of an acid catalyst; and a curing step of curing the cured-product precursor by polymerizing at least a portion of ethylenically unsaturated bonds in the cured-product precursor. Also, the present invention is a cured product prepared by said method. (In formulae (1) to (5): (X) is a siloxane bond producing group; R¹, R², and R⁴ are each a group selected from among a hydrogen atom, an alkyl group, an aralkyl group, a cycloalkyl group, a cycloaralkyl group, an aryl group, and a group having an ethylenically unsaturated bond; R³ and R⁵ are each a group selected from among a hydrogen atom, an alkyl group, an aralkyl group, a cycloalkyl group, a cycloaralkyl group, and an aryl group; and at least one of R¹, R², and R⁴ is a group having an ethylenically unsaturated bond.)

### FIELD OF THE INVENTION

The present invention relates to a thermal shock-resistant cured product that exhibits excellent thermal shock resistance, and may be used as an adhesive material, a sealing material, a protective layer, and the like used for electronic parts incorporated in a semiconductor device, a printed circuit board, and the like, and a method for producing the same.

### BACKGROUND ART

An electronic device (e.g., semiconductor device or printed circuit board) includes a substrate formed of a resin, glass, a metal, or the like, and various electronic parts provided on the substrate. The electronic parts are secured using solder, an adhesive, or the like corresponding to the objective or application.

Lead-free solder has been increasingly used as solder for bonding the electronic parts to the substrate instead of tin-lead-based solder from the viewpoint of environmental issues. Since the melting point (220° C.) of the lead-free solder is higher than that of the tin-lead-based solder, the solder reflow temperature used for the electronic circuit board has been increased from 230° C. to 260° C. when using the lead-free solder. A material that can endure thermal shock at a temperature of 260° C. has been desired for the electronic circuit board.

The amount of heat generated from the semiconductor device has increased along with an increase in the degree of integration and capacity of the semiconductor chip, while the housing of the electronic device in which the semiconductor device is incorporated has been reduced in weight and dimensions. Therefore, the density of the electronic parts provided in the electronic device has increased, and the electronic circuit board and the electronic parts have been subjected to a severe thermal environment. A rapid change in temperature repeatedly occurs due to a change in load or a change in environment that occurs when the electronic device is used. A light-emitting diode (LED) is also subjected to such a situation. Since the LED may be used in a severe environment (e.g., outdoors) along with the widespread use of the LED, a protective film has been increasingly desired for parts that generate heat. However, it may be difficult to sufficiently remove heat when a large amount of heat is generated from the LED along with an increase in luminance, and the protective film may undergo separation or produce crack due to thermal shock when the temperature of the electronic parts including the LED changes to a large extent each time the LED is turned ON/OFF. Therefore, a cured film that exhibits high thermal shock resistance has been desired as an electronic circuit material.

Patent Document 1 discloses a substrate provided with a heat-curable silicone polymer-containing resin obtained by reacting a silane compound represented by R′ₘ(H)ₖSiX₄₋₍ₘ₊ₖ₎ with a hydrosilation agent. Patent Document 1 states that cracks did not occur when the solder reflow process was performed at a temperature of 288° C. for 30 seconds (see the Examples). A high-temperature reaction or a catalyst (e.g., chloroplatinic acid) is necessary in order to effect hydrosilation. However, a high-temperature reaction adversely affects the semiconductor chip. When using a catalyst, it may be difficult to remove the catalyst after completion of the reaction, or a deterioration such as discoloration tends to occur when a polymer that contains the residual catalyst is used. Therefore, the above resin is not sufficient for use in electronic material applications and protective film applications.

Patent Document 2 discloses a polysiloxane compound obtained by subjecting at least two alkoxysilanes to hydrolysis and polycondensation under alkaline conditions as a polysiloxane compound that is produced without using hydrosilation, for example. However, Patent Document 2 is silent about the thermal shock resistance of the resulting cured product. A polysiloxane compound obtained by subjecting at least two alkoxysilanes to hydrolysis and polycondensation under acidic conditions is not employed due to storage stability. Specifically, a polysiloxane compound obtained by subjecting at least two alkoxysilanes to hydrolysis and polycondensation, and a curable composition including the polysiloxane compound have been known in the art. However, a technical problem for obtaining a cured product that exhibits high thermal shock resistance has not been studied, and a method and a specific composition that make it possible to produce a cured product that exhibits high thermal shock resistance have not been known.

### PRIOR TECHNICAL DOCUMENT

### Patent Document

[Patent Document 1] JP-A 2011-61211
[Patent Document 2] WO2009/131038

### SUMMARY OF THE INVENTION

### Problems that the Invention is to Solve

An objective of the present invention is to provide a cured product that exhibits excellent thermal shock resistance, and rarely undergo separation from a substrate formed of a metal, glass, a resin, or the like, and a method for producing the same.

### Means for Solving the Problems

The present inventors found that a cured product exhibiting excellent thermal shock resistance and excellent adhesion to a substrate can be obtained by a method including a condensation step that subjects a monomer represented by the following general formula (1), a monomer represented by the following general formula (2), a monomer represented by the following general formula (3), a monomer represented by the following general formula (4), and a monomer represented by the following general formula (5) to copolycondensation in a ratio of a mol, w mol, x mol, y mol, and c mol in the presence of an acid catalyst to obtain a cured product precursor, and a curing step that subjects at least some of the ethylenically unsaturated bonds included in the cured product precursor to polymerization to cure the cured product precursor, wherein w and x are independently a positive number, a, y, and c are independently 0 or a positive number, and a, w, x, y, and c satisfy a relationship “0<w/(a+x+y+2c)≦10”.

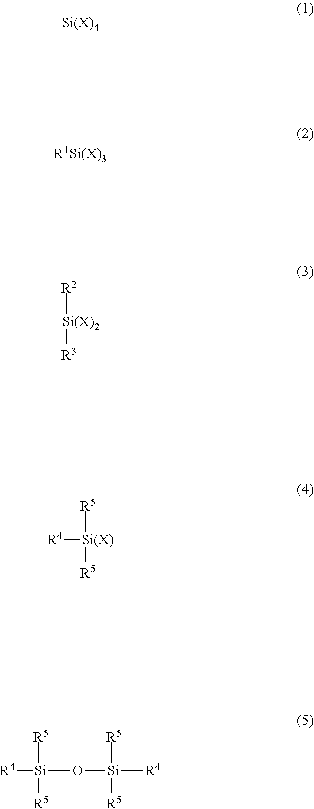

In the general formulae (1) to (5), (X) is a siloxane bond-forming group, R¹, R², and R⁴ are independently a group selected from a hydrogen atom, an alkyl group, an aralkyl group, a cycloalkyl group, a cycloaralkyl group, an aryl group, and a group having an ethylenically unsaturated bond, and R³ and R⁵ are independently a group selected from a hydrogen atom, an alkyl group, an aralkyl group, a cycloalkyl group, a cycloaralkyl group, and an aryl group, provided that at least one of R¹, R², and R⁴ is the group having an ethylenically unsaturated bond. When a plurality of (X) in the monomers is present, some or all of the plurality of (X) are either identical or different. Some or all of the plurality of R⁴ in the general formula (5) are either identical or different, and some or all of the plurality of R⁵ in the general formulae (4) and (5) are either identical or different.

### Effect of the Invention

The cured product of the present invention rarely produces cracks even when repeatedly subjected to thermal shock (i.e., exhibits excellent thermal shock resistance). When the cured product is bonded to a substrate, the cured product is rarely separated from the substrate. Therefore, the cured product is useful as a protective layer that protects the substrate from water and air. When the cured product is provided between two members, or provided in a gap between two substrates, the cured product functions as an excellent interlayer bonding material that exhibits excellent thermal shock resistance since the cured product is not easily separated even when repeatedly subjected to thermal shock.

When the monomers respectively represented by the general formulae (1) to (5) are subjected to copolycondensation in the presence of the acid catalyst, the monomers are incorporated in the copolycondensate approximately corresponding to the number of parts of each monomer to obtain a cured product precursor. Therefore, the amounts of the monomers respectively represented by the general formulae (1) to (5) are determined corresponding to the composition of the desired cured product precursor. The composition of the cured product precursor can be determined by an arbitrary analysis method (e.g., NMR), and a cured product precursor that exhibits the desired performance can be obtained by finely adjusting the amount of each monomer based on the analysis results.

### EMBODIMENTS FOR CARRYING OUT THE INVENTION

Hereinafter, the present invention is described in detail. In the description of the present invention, “(meth)acryl” means acryl and methacryl, “(meth)acrylate” means acrylate and methacrylate, and “(meth)acryloyl” means acryloyl and methacryloyl.

The production method of the thermal shock-resistant cured product in the present invention includes a condensation step that subjects a monomer represented by the following general formula (1), a monomer represented by the following general formula (2), a monomer represented by the following general formula (3), a monomer represented by the following general formula (4), and a monomer represented by the following general formula (5) to copolycondensation in a ratio of a mol, w mol, x mol, y mol, and c mol in the presence of an acid catalyst to obtain a cured product precursor, and a curing step that subjects at least some of the ethylenically unsaturated bonds included in the cured product precursor to polymerization to cure the cured product precursor.

The monomers respectively represented by the general formulae (1) to (5) may respectively be used either alone or in combination.

In the general formulae (1) to (5), (X) is a siloxane bond-forming group that forms a siloxane bond through condensation. A monomer having four siloxane bond-forming groups in the molecule is referred to as “Q monomer”. A monomer having three siloxane bond-forming groups in the molecule is referred to as “T monomer”, a monomer having two siloxane bond-forming groups in the molecule is referred to as “D monomer”, and a monomer having one siloxane bond-forming group in the molecule is referred to as “M monomer”. The monomer represented by the general formula (1) is a Q monomer, the monomer represented by the general formula (2) is a T monomer, the monomer represented by the general formula (3) is a D monomer, and the monomer represented by the general formula (4) is a M monomer. The monomer represented by the general formula (5) is a monomer that produces two constituent units similar to the constituent unit produced by the M monomer through copolycondensation. The monomer represented by the general formula (5) is referred to as “M2 monomer”.

When a plurality of Q monomers is subjected to condensation, a condensate having a structural unit having four siloxane bonds is obtained. The structural unit included in the condensate is referred to as “Q unit”. A T unit having three siloxane bonds is produced from the T monomer, a D unit having two siloxane bonds is produced from the D monomer, and an M unit having one siloxane bond is produced from the M monomer. Since the M unit has an effect of terminating a condensed chain having a siloxane bond to protect the end of the condensed chain, the M unit may be referred to as “capping agent”.

Examples of the siloxane bond-forming group (X) include a hydroxyl group and a hydrolyzable group. Examples of the hydrolyzable group include a halogeno group, an alkoxy group, and the like. Among these, an alkoxy group is preferable since an alkoxy group exhibits excellent hydrolyzability, and does not produce an acid as a by-product. An alkoxy group having 1 to 3 carbon atoms is more preferable.

Examples of the monomer represented by the general formula (1) include tetramethoxysilane, tetraethoxysilane, tetra-n-propoxysilane, tetra-n-butoxysilane, and the like. Among these, tetramethoxysilane, tetraethoxysilane, tetra-n-propoxysilane, and the like are preferable due to availability and excellent hydrolyzability.

At least one of R¹, R², and R⁴ in the general formulae (2) to (5) is a group having an ethylenically unsaturated bond. It is preferable that R¹ in the general formula (2) is a group having an ethylenically unsaturated bond. This is because it is easy to obtain the T monomer having a group that includes an ethylenically unsaturated bond.

The group having an ethylenically unsaturated bond is a group having an acryloyl group or methacryloyl group, and is more preferably an organic group represented by the following general formula (6).

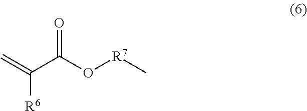

In the general formula (6), R⁶ is a hydrogen atom or a methyl group, and some or all of the plurality of R⁶ are either identical or different. R⁷ is an alkylene group having 1 to 6 carbon atoms, and some or all of the plurality of R⁷ are either identical or different.

In the general formula (6), R⁷ is preferably a propylene group. This is because it is easy to obtain or synthesize a compound that produces an organic functional group having a propylene group. R⁶ is preferably a methyl group or a hydrogen atom, and is more preferably a hydrogen atom.

In the present invention, it is preferable to use monomers so that at least one of R¹, R², and R⁴ is a group having an ethylenically unsaturated bond, and subject at least some of the ethylenically unsaturated bonds to polymerization to obtain a cured product in which the polymer chain includes a carbon-carbon single bond. When the group having an ethylenically unsaturated bond is the group represented by the general formula (6), the polymer chain having a carbon-carbon single bond is represented by the following general formula (7).

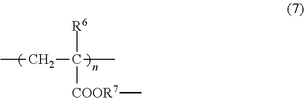

In the general formula (7), n that indicates the degree of polymerization is preferably in a range from 1 to 100, and more preferably from 2 to 50.

The cured product precursor obtained by the condensation step includes a structural unit derived from the monomers represented by the general formulae (1) to (5) (i.e., siloxane structure). Since the monomer represented by the general formula (2) is necessarily used in the present invention, the resulting cured product precursor includes a silsesquioxane structure having an —Si—O— group. When the cured product precursor is subjected to the curing step, a cured product is obtained having a carbon-carbon polymer chain structure derived from the silsesquioxane structure and the ethylenically unsaturated bonds included in the monomers represented by the general formulae (2) to (5). It is preferable that the cured product has a structure in which the silsesquioxane structure having the —Si—O— group has a number of linear structural sites.

The Q monomer represented by the general formula (1) forms a Q unit through the condensation step. When the resulting cured product includes a Q unit, the cured product tends to exhibit improved heat resistance. However, when the Q unit content in the cured product is too high, cracks may easily occur due to thermal shock. Therefore, the Q monomer is used so that the molar ratio “a/(a+w+x+y+2c)” (i.e., the molar ratio of the amount (a) of Q monomer to the amount (a+w+x+y+2c) of the monomers respectively represented by the general formulae (1) to (5)) is preferably in a range from 0 to 1, and more preferably from 0 to 0.4.

The T monomer represented by the general formula (2) is an indispensable raw material. The amount w of T monomer is determined so that the amount w of T monomer, the amount a of Q monomer, the amount x of D monomer, the amount y of M monomer, and the amount c of M2 monomer satisfy a relationship of preferably “0<w/(a+x+y+2c)≦10”, more preferably “0.01≦w/(a+x+y+2c)≦5”, further preferably “0.1≦w/(a+x+y+2c)≦2”, and particularly “0.4≦w/(a+x+y+2c)≦1.2”.

In the general formula (2), R¹ is a group selected from a hydrogen atom, an alkyl group, an aralkyl group, a cycloalkyl group, a cycloaralkyl group, an aryl group, and a group having an ethylenically unsaturated bond. Among these, a group having an ethylenically unsaturated bond is preferable.

Examples of the T monomer represented by the general formula (2) include triethoxysilane, tripropoxysilane, methyltrimethoxysilane, methyltriethoxysilane, benzyltrimethoxysilane, cyclohexyltrimethoxysilane, phenyltrimethoxysilane, phenyltriethoxysilane, vinyltrimethoxysilane, vinyltriethoxysilane, (p-styryl)trimethoxysilane, (p-styryl)triethoxysilane, (3-methacryloyloxypropyl)trimethoxysilane, (3-methacryloyloxypropyl)triethoxysilane, (3-acryloyloxypropyl)trimethoxysilane, (3-acryloyloxypropyl)triethoxysilane, and the like. Among these, (3-methacryloyloxypropyl)trimethoxysilane (3-methacryloyloxypropyl)triethoxysilane, (3-acryloyloxypropyl)trimethoxysilane, and (3-acryloyloxypropyl)triethoxysilane are preferable due to availability.

The D monomer represented by the general formula (3) is an indispensable raw material. In the general formula (3), R² is a group selected from a hydrogen atom, an alkyl group, an aralkyl group, a cycloalkyl group, a cycloaralkyl group, an aryl group, and a group having an ethylenically unsaturated bond. R³ is a group selected from a hydrogen atom, an alkyl group, an aralkyl group, a cycloalkyl group, a cycloaralkyl group, and an aryl group. The D monomer is preferably a compound in which R² and R³ are selected from a methyl group and a phenyl group, and more preferably a compound in which both R² and R³ are methyl groups in the present invention.

Examples of the D monomer represented by the general formula (3) include dimethoxydimethylsilane, dimethoxydiethylsilane, diethoxydimethylsilane, diethoxydiethylsilane, dimethoxymethylphenylsilane, diethoxymethylphenylsilane, dimethoxybenzylmethylsilane, dimethoxy(3-methacryloyloxypropyl)methylsilane, diethoxy(3-methacryloyloxypropyl)methylsilane, dimethoxy(3-acryloyloxypropyl)methylsilane, diethoxy(3-acryloyloxypropyl)methylsilane, and the like. Among these, dimethoxydimethylsilane, diethoxydimethylsilane and dimethoxymethylphenylsilane are preferable due to availability.

In the general formula (4), R⁴ is a group selected from a hydrogen atom, an alkyl group, an aralkyl group, a cycloalkyl group, a cycloaralkyl group, an aryl group, and a group having an ethylenically unsaturated bond. R⁵ is a group selected from a hydrogen atom, an alkyl group, an aralkyl group, a cycloalkyl group, a cycloaralkyl group, and an aryl group. The M monomer is preferably a compound in which R⁴ and R⁵ are selected from a methyl group and a phenyl group, and more preferably a compound in which both R⁴ and R⁵ are methyl groups in the present invention. Since the M monomer includes one siloxane bond-forming group, and has a function of terminating the end of the polysiloxane condensed chain, the M monomer can be used to control the molecular weight of the polysiloxane (cured product precursor) in the production method of the cured product of the invention.

Examples of the M monomer represented by the general formula (4) include methoxytrimethylsilane, methoxytriethylsilane, ethoxytrimethylsilane, ethoxytriethylsilane, methoxydimethylphenylsilane, ethoxydimethylphenylsilane, trimethylchlorosilane, triethylchlorosilane, trimethylbromosilane, triethylbromosilane, and the like.

Among these, trimethylchlorosilane and trimethylbromosilane are preferable and trimethylchlorosilane is particularly preferable from the viewpoint of cost. In the present invention, at least one of the M monomer represented by the general formula (4) and the M2 monomer represented by the general formula (5) may be used in fractions. Specifically, part of at least one of the M monomer represented by the general formula (4) and the M2 monomer represented by the general formula (5) may be used in the condensation step, and the remainder may be used in an end-capping step (described later) performed between the condensation step and the curing step. The M monomer and the M2 monomer may not be used in the condensation step and may be used only in the end-capping step. When the M monomer represented by the general formula (4) is a compound having a halogeno group as the siloxane bond-forming group, reactivity in the end-capping step can be improved.

In the general formula (5), R⁴ is a group selected from a hydrogen atom, an alkyl group, an aralkyl group, a cycloalkyl group, a cycloaralkyl group, an aryl group, and a group having an ethylenically unsaturated bond. R⁵ is a group selected from a hydrogen atom, an alkyl group, an aralkyl group, a cycloalkyl group, a cycloaralkyl group, and an aryl group.

The M2 monomer represented by the general formula (5) produces two M units (from one molecule) through copolycondensation.

Examples of the M2 monomer represented by the general formula (5) include 1,1,3,3-tetramethyldisiloxane, 1,1,3,3-tetraethyldisiloxane, hexamethyldisiloxane, hexaethyldisiloxane, hexapropyldisiloxane, and the like. Among these, hexamethyldisiloxane is preferable due to availability.

Each step is described in detail below.

In the condensation step, specific amounts of the monomers represented by the general formulae (1) to (5) are subjected to copolycondensation in the presence of an acid catalyst to produce a cured product precursor.

The acid catalyst used in the condensation step is not particularly limited. The acid catalyst is preferably an acid having a pKa (acid dissociation constant) in water of 4.0 or less. Specifically, an inorganic strong acid such as hydrochloric acid, sulfuric acid, and nitric acid is preferable. The acid catalyst is more preferably hydrochloric acid, nitric acid, and sulfuric acid. Among these, hydrochloric acid is particularly preferable since hydrochloric acid can be volatilized (i.e., a neutralization step is not indispensable), and a side reaction due oxidizing power does not occur, for example. The usage amount of the acid catalyst is normally in a range from 0.01 to 20 mol, preferably from 0.1 to 10 mol, and more preferably from 1 to 5 mol based on 100 mol of the monomers represented by the general formulae (1) to (5) in total.

It is preferable to effect copolycondensation in the condensation step in the presence of the acid catalyst and water. When some or all of the siloxane bond-forming groups included in the monomers represented by the general formulae (1) to (5) are hydrolyzable groups, it is preferable to use water in an amount equal to or more than the total equivalent of the hydrolyzable groups. The upper limit of the amount of water in the reaction system is preferably 100 times the total equivalent of the hydrolyzable groups. When effecting copolycondensation in the presence of the acid catalyst and water, it is preferable to use an appropriate amount of a hydrochloric acid aqueous solution at a concentration of 0.1% to 10% by mass.

It is convenient to employ a constant reaction temperature in the condensation step, but preferable method is one in which the reaction temperature is be gradually increased. If the reaction temperature is too high, it may be difficult to control the reaction, and the energy cost may increase. Moreover, when the raw materials include an ethylenically unsaturated bond, decomposition may occur. If the reaction temperature is too low, the reaction may take time, and hydrolysis and polycondensation may become insufficient. The upper limit of the reaction temperature is preferably 100° C., more preferably 80° C., and further preferably 60° C. The lower limit of the reaction temperature is preferably 0° C., more preferably 15° C., and further preferably 25° C.

The condensation step may utilize a reaction solvent that is capable of dissolving the monomers for forming the cured product precursor, the acid catalyst, water, and an additional component. The reaction solvent is preferably an alkyl alcohol, a propylene glycol monoalkyl ether, and a compound having one alcoholic hydroxyl group in the molecule. Specific examples of the reaction solvent include methanol, ethanol, 1-propanol, 2-propanol, 1-butanol, 2-butanol, isobutyl alcohol, t-butyl alcohol, 2-methyl-1-butanol, 3-methyl-1-butanol, 2,2-methyl-1-propanol, 1-pentanol, 2-pentanol, 1-octanol, 3-methyl-2-butanol, 3-pentanol, 2-methyl-2-butanol, cyclopentanol, propylene glycol monomethyl ether, propylene glycol monoethyl ether, propylene glycol monopropyl ether, propylene glycol monobutyl ether, and the like. It is preferable to use a compound having a boiling point of less than 100° C. as the reaction solvent since such a compound can be easily volatilized (removed) after the reaction in the present invention. The reaction solvent is more preferably selected from methanol, ethanol, 1-propanol, 2-propanol, and t-butyl alcohol.

The D monomer represented by the general formula (3) having two siloxane bond-forming groups produces a linear condensed molecule through condensation. On the other hand, the monomer represented by the general formula (2) having three siloxane bond-forming groups, and the monomer represented by the general formula (1) having four siloxane bond-forming groups produce a cured product precursor having a three-dimensional crosslinked structure. A ladder-like or cage-like structure is formed depending on the degree of condensation. A structure in which some of the siloxane bond-forming groups (X) remain may be formed due to steric hindrance and the like.

The siloxane bond-forming groups (X) that remain without being condensed are hydrolyzed (excluding a case where the condensation step is performed in the absence of water) to obtain a condensate in which the siloxane bond-forming groups (X) are converted into OH bonded to the Si atom (silanol). The siloxane bond-forming group (X) that remains without being condensed, is converted into an OH group that forms an Si—OH group. The Si—OH group content can be determined by analyzing a condensate obtained using specific amounts of monomers. The amount of residual Si—OH groups can also be determined by analyzing a product produced by subjecting a condensate that has been obtained using specific amounts of monomers and includes the Si—OH groups to the end-capping step that utilizes at least one of the M monomer and the M2 monomer having high reactivity.

When the monomer represented by the general formula (1) and the monomer represented by the general formula (2) include a siloxane bond-forming group, and all of the siloxane bond-forming groups have formed a siloxane bond through condensation, the resulting condensate has too strong a crosslinked structure with a low degree of freedom. In this case, the resulting cured product easily breaks when subjected to an impact resistance test. In contrast, when some of the siloxane bond-forming groups included in the monomer represented by the general formula (1) and the monomer represented by the general formula (2) remain uncondensed to form a condensate having a number of linear structural sites, the molecules of the condensate are easily deformed even when the monomer composition is identical. In this case, the resulting cured product rarely breaks when subjected to an impact resistance test.

When part of at least one of the M monomer represented by the general formula (4) and the M2 monomer represented by the general formula (5) is used in the condensation step, and the remainder is used in the end-capping step, the end-capping step can be effected in the reaction system subjected to the condensation step. When the M monomer and the M2 monomer are not used in the condensation step, the M monomer and the M2 monomer may be used only in the end-capping step.

The condensate obtained by the condensation step normally includes an —Si—OH group. When the Si—OH group content in the condensate is high, a cured product precursor that produces a preferable thermal shock-resistant cured product can be obtained by performing the end-capping step that reacts the Si—OH groups with the remaining M monomer.

When the monomers represented by the general formulae (1) to (5) are condensed in the presence of the acid catalyst, the monomer represented by the general formula (1) and the monomer represented by the general formula (2) are easily linearly condensed, and a cured product that rarely breaks when subjected to an impact resistance test can be obtained by subjecting the resulting condensate to the curing step. When a condensate having such a linear structure is obtained by the condensation step or the end-capping step, a condensate having an Si—OH group as the remaining siloxane bond-forming group can be confirmed. Specifically, the cured product precursor is preferably one having an Si—OH group. When the Si—OH group content is z mol, a cured product that exhibits high thermal shock resistance can be obtained when a, w, x, y, c, and z satisfy a relationship of “0.05≦z/(a+w+x+y+2c)≦1.0”, and more preferable is “0.1≦z/(a+w+x+y+2c)≦0.6”.

When producing the cured product precursor using the condensation step, the following steps (hereinafter may be referred to as “post-steps”) may be performed after the condensation step. These steps may be performed either alone or in combination. When an organic solvent such as the reaction solvents does not undergo phase separation with water, a solvent replacement step may be further provided to replace the organic solvent with an organic solvent that can be separated from water. It is preferable to omit a neutralization step and a water washing step by volatilizing (removing) a volatile catalyst after completion of the reaction. It is more preferable to volatilize (remove) the catalyst in a concentration step.

The neutralization step is a step that neutralizes the reaction mixture obtained by the condensation step using an alkali.

The water washing step is a step that washes the condensate included in the neutralized mixture with water.

The concentration step is a step that concentrates the aqueous liquid including the condensate. The concentration step includes removal of the solvent.

The solvent replacement step is a step that dissolves the concentrate subjected to concentration or removal of the solvent in another organic solvent.

The end-capping step is a step that reacts the M monomer with the compound having residual Si—OH groups.

The cured product precursor or a cured product precursor solution can be obtained by performing the condensation step, or further performing the post-steps. The molecular weight and the like of the resulting polymer or polymer solution can be analyzed in this stage. The residual siloxane bond-forming group (including a hydrolyzable group) content may be calculated from the integral intensity ratio of each peak on the ¹H-NMR (nuclear magnetic resonance spectrum) chart. It is preferable that substantially all of the hydrolyzable groups are hydrolyzed. It is determined that substantially all of the hydrolyzable groups are hydrolyzed when a peak attributed to the hydrolyzable group is substantially not observed on the ¹H-NMR chart of the resulting cured product precursor, for example. The number average molecular weight of the cured product precursor can be determined by gel permeation chromatography (GPC). The standard polystyrene-reduced number average molecular weight of the cured product precursor is preferably in a range from 500 to 100,000, more preferably from 800 to 50,000, and further preferably from 1,000 to 20,000.

The cured product precursor obtained by performing the condensation step, or further performing the post-steps may have been dissolved in an organic solvent. Specifically, the cured product precursor may be in the form of a cured product precursor solution. The organic solvent is not particularly limited. It is preferable to utilize the reaction solvent as the organic solvent from the economical point of view. It is also preferable to use an additional organic solvent in order to improve the leveling properties during application.

The cured product precursor solution may include an additional component as long as the storage stability of the cured product precursor solution is not impaired. Examples of the additional component include a polymerizable unsaturated compound, a radical polymerization inhibitor, an antioxidant, a UV absorber, a light stabilizer, a leveling agent, an organic polymer, a filler, metal particles, a pigment, an initiator, a sensitizer, and the like.

In the curing step, a curable composition containing the cured product precursor, an initiator, and an organic solvent is normally used, a coat of the composition is formed in a given area, and heat or light is applied to the coat.

The cured product precursor may be cured by the above method to obtain a cured product. In the curing step, heating, application of active energy rays, or a combination thereof may be used. In the curing step, at least some of the ethylenically unsaturated bonds included in the cured product precursor are subjected to polymerization to crosslink the cured product precursor to obtain a cured product. Since the cured product obtained by the curing step includes a crosslinked structure formed by subjecting the ethylenically unsaturated bonds to polymerization, the cured product exhibits excellent flexibility and adhesion as compared with a cured product obtained by only condensation. Since the cured product also includes a crosslinked structure formed by condensation, the cured product includes a crosslinked structure that exhibits excellent heat resistance as compared with a cured product obtained by merely subjecting ethylenically unsaturated bonds to polymerization. Therefore, the cured product exhibits excellent hardness, mechanical strength, chemical resistance, and adhesion to a substrate formed of a metal, glass, a resin, or the like, for example.

The polymerizable unsaturated compound is preferably a compound having an ethylenically unsaturated bond, more preferably a (meth)acrylate compound having a (meth)acryloyl group, and particularly a monofunctional (meth)acrylate, a polyfunctional (meth)acrylate, a urethane (meth)acrylate, or the like. These compounds may be used singly or in combination of two or more types thereof. When a polyfunctional (meth)acrylate compound is used, the resulting thermal shock-resistant cured product is provided with a crosslinked structure.

Examples of the radical polymerization inhibitor that is used to stabilize the ethylenically unsaturated bonds include a phenol-based compound such as hydroquinone and hydroquinone monomethyl ether; an N-nitrosophenylhydroxylamine salts; and the like.

Examples of the antioxidant include a hindered phenol-based antioxidant such as 2,6-di-t-butyl-4-methylphenol and pentaerythritol tetrakis(3-(3,5-di-t-butyl-4-hydroxyphenyl)propionate); a sulfur-based secondary antioxidant such as 4,6-bis(octylthiomethyl)-o-cresol; a phosphorus-based secondary antioxidant; and the like. These compounds may be used singly or in combination of two or more types thereof. The radical polymerization inhibitor and the antioxidant improve the storage stability, the thermal stability, and the like of the curable composition and the thermal shock-resistant cured product.

In the case where the curable composition includes the radical polymerization inhibitor, a content of the radical polymerization inhibitor is preferably in a range from 1 to 10,000 parts by mass, more preferably from 10 to 2,000, and further preferably from 100 to 500 parts by mass based on 1,000,000 parts by mass of the cured product precursor.

In the case where the curable composition includes the antioxidant, a content of the antioxidant is preferably in a range from 1 to 10,000 parts by mass, more preferably from 10 to 2,000, and further preferably from 100 to 500 parts by mass based on 1,000,000 parts by mass of the cured product precursor.

Examples of the UV absorber include a hydroxyphenyltriazine-based UV absorber such as 2-[4-[(2-hydroxy-3-dodecyloxypropyl)oxy]-2-hydroxyphenyl]-4,6-bis(2,4-dimethylphenyl)-1,3,5-triazine; a benzotriazole-based UV absorber such as 2-(2H-benzotriazol-2-yl)-4,6-bis(1-methyl-1-phenylethyl)phenol; an inorganic fine particle that absorbs UV rays, such as a titanium oxide particle and a zinc oxide particle; and the like. These components may be used singly or in combination of two or more types thereof. Examples of the light stabilizer include a hindered amine-based light stabilizer such as bis(1,2,2,6,6-pentamethyl-4-piperidinyl)sebacate, and the like. The UV absorber and the light stabilizer respectively improve UV resistance and weatherability.

Examples of the leveling agent include a silicone-based polymer, a fluorine-containing polymer, and the like. The leveling agent improves leveling properties when applying the curable composition to the surface of a substrate formed of a metal, glass, a resin, or the like.

Examples of the organic polymer include a (meth)acrylic polymer. Examples of a preferable monomer for the (meth)acrylic polymer include methyl methacrylate, cyclohexyl (meth)acrylate, N-(2-(meth)acryloxyethyl)tetrahydrophtalimide, and the like. Examples of the filler in the additional component include silica filler, alumina filler, and the like.

The concentration of the cured product precursor dissolved in the curable composition is not particularly limited and is preferably in a range from 0.1% to 70% by mass, more preferably from 0.5% to 50% by mass, and further preferably from 1% to 30% by mass.

In the curing step, at least some of the ethylenically unsaturated bonds included in the cured product precursor can be subjected to polymerization by application of active energy rays, heating, or a combination thereof. An appropriate polymerization initiator may be selected and added depending on the objective. Examples of a preferable photoinitiator include an acetophenone-based compound such as 2,2-dimethoxy-1,2-diphenylethan-1-one, 1-hydroxycyclohexyl phenyl ketone, 2-hydroxy-2-methyl-1-phenyl-propan-1-one, 1-[4-(2-hydroxyethoxy)phenyl]-2-hydroxy-2-methyl-1-propan-1-one, 2-methyl-1-[4-(methylthio)phenyl]-2-morpholinopropan-1-one, 2-benzyl-2-dimethylamino-1-(4-morpholinophenyl)butan-1-one, diethoxyacetophenone, oligo[2-hydroxy-2-methyl-1-[4-(1-methylvinyl)phenyl]propanone], 2-hydroxy-1-{4-[4-(2-hydroxy-2-methylpropionyl)benzyl]phenyl}-2-methylpropan-1-one, and 2,2-dimethoxy-2-phenylacetophenone; a benzophenone-based compound such as benzophenone, 4-phenylbenzophenone, 2,4,6-trimethylbenzophenone, and 4-benzoyl-4′-methyldiphenyl sulfide; an α-keto ester-based compound such as methylbenzoyl formate, 2-(2-oxo-2-phenylacetoxyethoxy)ethyl oxyphenylacetate, and 2-(2-hydroxyethoxy)ethyl oxyphenylacetate; a phosphine oxide-based compound such as 2,4,6-trimethylbenzoyl diphenylphosphine oxide, bis(2,4,6-trimethylbenzoyl) phenylphosphine oxide, and bis(2,6-dimethoxybenzoyl)-2,4,4-trimethylpentylphosphine oxide; a benzoin-based compound such as benzoin, benzoin methyl ether, benzoin ethyl ether, benzoin isopropyl ether, and benzoin isobutyl ether; a titanocene-based compound; an acetophenone/benzophenone hybrid photoinitiator such as 1-(4-(4-benzoylphenylsulfanyl)phenyl)-2-methyl-2-(4-methylphenylsulfinyl)propan-1-one; an oxime ester-based photoinitiator such as 1,2-octanedione and 1-[4-(phenylthio)-1,2-(o-benzoyloxime)]; camphorquinone; and the like. These photoinitiator may be used either alone or in combination. Different types of photoinitiators may be used in combination.

Examples of a preferable thermal initiator include a peroxide such as dicumyl peroxide, benzoyl peroxide, t-butyl peroxy-2-ethylhexanoate, 1,1,3,3-tetramethylbutyl peroxy-2-ethylhexanoate, 1-cyclohexyl-1-methylethyl peroxy-2-ethylhexanoate, t-butylperoxy benzoate, lauroyl peroxide, and cumene hydroperoxide, and an azo-based initiator such as 2,2′-azobisisobutyronitrile (AIBN), 1,1′-azobis(cyclohexane-1-carbonitrile), 2,2′-azobis[2-methyl-N-(2-hydroxyethyl)propionamide], and 2,2′-azobis[2-(2-imidazolin-2-yl)propane].

A content of the polymerization initiator is preferably in a range from 0.1 to 10 parts by mass, more preferably from 0.3 to 5 parts by mass, and further preferably from 0.5 to 3 parts by mass based on 100 parts by mass of the cured product precursor.

In the curing step, it is preferable to cure the cured product precursor by applying light (more preferably active energy rays). When a coat includes an organic solvent, it is preferable to cure the cured product precursor after removing most of the solvent by heating/drying or the like.

Specific examples of the active energy rays include electron beams, UV rays, visible light, and the like. It is particularly preferable to use UV rays. Examples of a UV irradiation device include a high-pressure mercury lamp, a metal halide lamp, a UV electrodeless lamp, an LED, and the like. The irradiation energy (dose) is appropriately set corresponding to the type of active energy rays and the compositional ratio. For example, when using a high-pressure mercury lamp, the irradiation energy (UV-A region) is preferably in a range from 100 to 5,000 mJ/cm², more preferably from 500 to 3,000 mJ/cm², and further preferably from 1,000 to 3,000 mJ/cm².

When thermally curing the cured product precursor in the curing step, the curing temperature is appropriately selected corresponding to the decomposition temperature for obtaining the half-life of the thermal initiator, but is preferably in a range from 30° C. to 200° C., more preferably from 40° C. to 150° C., and further preferably from 50° C. to 120° C.

The cured product precursor obtained by the production method of the present invention can be specifically represented by the following general formula (8).

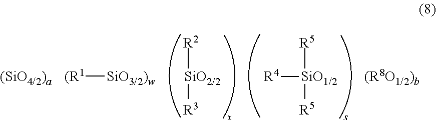

In the general formula (8), R¹, R², and R⁴ are independently a group selected from a hydrogen atom, an alkyl group, an aralkyl group, a cycloalkyl group, a cycloaralkyl group, an aryl group, and a group having an ethylenically unsaturated bond, R³ and R⁵ are independently a group selected from a hydrogen atom, an alkyl group, an aralkyl group, a cycloalkyl group, a cycloaralkyl group, and an aryl group, provided that at least one of R¹, R², and R⁴ is a group having an ethylenically unsaturated bond, and R⁸ is a group selected from a hydrogen atom, an alkyl group, an aralkyl group, a cycloalkyl group, a cycloaralkyl group, an aryl group, and a group having an ethylenically unsaturated bond. When a plurality of R¹ to R⁵ and R⁸ are respectively present in the molecule, some or all of the plurality of R¹ to R⁵ and R⁸ are respectively either identical or different.

R⁸ is identical with one of R¹ to R⁷, and is preferably a hydrogen atom.

w and x are independently a positive number, a and s are independently 0 or a positive number, and a, s, w, and x preferably satisfy a relationship “0<w/(a+x+s)≦10”.

When all of y mol of the M monomer and c mol of the M2 monomer are copolycondensed, s is y+2c.

A preferable range of b is the same as the preferable range of z. Specifically, the amount b is determined so that the amounts a, w, x, s, and b satisfy a relationship of preferably “0.05≦b/(a+w+x+s)≦1.0”, and more preferably “0.1≦b/(a+w+x+s)≦0.6”.

### EXAMPLES

Hereinafter, the present invention is specifically described using Examples. The present invention is not limited to these Examples. In the following, “%” is based on mass unless otherwise indicated.

Additionally, “AC-” means to an acryloyloxypropyl group, and “MAC-” means to a methacryloyloxypropyl group.

The polysiloxane included in the cured product precursor synthesized in each Example or Comparative Example was subjected to ¹H-NMR analysis as described below. About 1 g of the measurement sample and about 100 mg of hexamethyldisiloxane (hereinafter, referred to as “HMDSO”) as internal standard were accurately weighed, and dissolved in deuterated chloroform as analysis solvent, and analysis was performed based on the signal intensity of the proton of HMDSO.

The number average molecular weight refers to a standard polystyrene-reduced value determined by gel permeation chromatography (GPC).

The evaluation methods are described below.

### (1) Residual Si—OH Group Concentration

The residual Si—OH group concentration in the cured product precursor synthesized in each Example or Comparative Example was analyzed by the following method. The reaction mixture including the cured product precursor was concentrated. After removing the organic solvent, water, and the acid catalyst, the cured product precursor was dissolved in pyridine. A pyridine solution of trimethylchlorosilane having a specific concentration was added to the pyridine solution of the cured product precursor to effect a reaction, and unreacted trimethylchlorosilane was hydrolyzed, and removed by distillation. The trimethylsilyl group concentration in the cured product precursor that had increased due to the reaction was determined by ¹H-NMR to determine the residual Si—OH group concentration.

### (2) Evaluation of Thermal Shock Resistance

The thermal shock resistance was evaluated as described below. A 10 mm×10 mm frame was prepared using a polytetrafluoroethylene (PTFE) sheet having a thickness of 0.2 mm, and placed on a slide. The curable composition was put inside the frame, and the surface of the resulting film was smoothed using a spatula. UV rays were applied to the film using an electrodeless lamp valve (H valve) (lamp height: 10 cm, cumulative dose: 3 J) to form a cured product having a thickness of about 130 μm. The PTFE sheet frame was then removed to obtain a thermal shock resistance test cured product having a thickness of about 130 μm. The cured product was put in a thermostat container, heated at a temperature of 250° C. or higher for 2 minutes, and then heated at 260° C. for 30 seconds. The cured product was then allowed to cool at room temperature, and the presence or absence of separation of the cured product from the slide, and the presence or absence of cracks were determined with the naked eye. The above cycle was optionally repeated. In each example or comparative example, the thermal shock resistance was evaluated using three samples. The samples were subjected to up to 10 cycles. The test was terminated when cracks or separations occurred. The results are shown in Table 3.

### (3) Pencil Hardness Test

A pencil hardness test was performed as described below. The curable composition was applied to a slide using a bar coater. UV rays were applied to the curable composition using an electrodeless lamp valve (H valve) (lamp height: 10 cm, cumulative dose: 3 J) to form a cured product having a thickness of about 10 μm. The cured product was subjected to a pencil hardness test in accordance with JIS K 5600-5-4 (Testing methods for paints: Scratch hardness (Pencil method)) using a pencil manufactured by Mitsubishi Pencil Co., Ltd. The results are shown in Table 4.

The pencil hardness of each cured product shown in Table 4 indicates the hardness of the pencil used for the test.

### (4) Evaluation of External Appearance

The cured product subjected to the thermal shock resistance test was observed with the naked eye, and the external appearance of the cured product was evaluated in accordance with the following criteria.

1: The three cured products did not show cracks and separation.
2: One cured product among the three cured products showed cracks or separation.
3: Two cured products among the three cured products showed cracks or separation.
4: All of the three cured products showed cracks or separation.

### Example 1

### 1-1 Synthesis of Cured Product Precursor

A four-necked flask (500 mL) equipped with a three-one motor (stirrer), a dropping funnel, a reflux condenser, and a thermometer was charged with 113.46 g (484 mmol) of 3-acryloyloxypropyltrimethoxysilane, 32.43 g (270 mmol) of dimethoxydimethylsilane, and 45.19 g of 2-propanol. The mixture was then heated using a hot water bath. When the internal temperature of the reaction system had exceeded 40° C., 36.19 g of a 0.8% hydrochloric acid aqueous solution was added dropwise to the mixture from the dropping funnel while stirring the reaction system. The dropwise addition completed at about 50° C. Subsequently, the reaction system was allowed to stand at room temperature (about 25° C. (hereinafter the same)) for 15 hours. After the addition of 0.02 g of p-methoxyphenol and dissolution, the solvent was evaporated under reduced pressure while blowing air into the mixture to obtain 101.68 g of a cured product precursor (C1) (colorless transparent liquid). The cured product precursor (C1) had a viscosity of 1,970 mPa·s (25° C.) and a number average molecular weight of 1,300.

It was found by ¹H-NMR analysis that the compositional ratio of T units (AC—SiO_{3/2}) including an acryloyl group to D units (Me₂-SiO_{2/2}) including a dimethyl group was close to the molar ratio of the raw materials (see Table 2). The residual isopropoxy group content was 0.03 mol based on 1 mol of AC—SiO_{3/2}.

### 1-2 Measurement of Residual Si—OH Group Concentration

A four-necked flask (200 mL) equipped with a three-one motor (stirrer), a dropping funnel, a reflux condenser, and a thermometer was charged with 30 mL of pyridine. 19 mL of trimethylchlorosilane was then added dropwise to the flask using the dropping funnel (at room temperature) to obtain a pyridine solution of trimethylchlorosilane. Separately, a recovery flask (100 mL) was charged with 20.00 g of the cured product precursor (C1) synthesized in Example 1, and 30 mL of pyridine was added to the flask to dissolve the cured product precursor (C1) to obtain a pyridine solution of the cured product precursor (C1). The pyridine solution of the cured product precursor (C1) was added dropwise to the pyridine solution of trimethylchlorosilane at room temperature using the dropping funnel, and the mixture was stirred at a temperature of 75° C. for 3 hours. After the addition of 3 g of water to the reaction mixture, 0.002 g of aluminum N-nitrosophenylhydroxylamine “Q-1301” manufactured by Wako Pure Chemical Industries, Ltd. (hereinafter referred to as “polymerization inhibitor”) was added to the mixture, and the solvent was evaporated under reduced pressure to concentrate the mixture. Subsequently 50.00 g of diisopropyl ether was added to dissolve the residue, 20.00 g of water was added to the solution, and a washing operation was performed using a separating funnel. The washing operation was repeated seven times in total. After the addition of 0.002 g of the polymerization inhibitor to dissolve the organic layer, the solvent was evaporated under reduced pressure to obtain a trimethylsilylated product of the cured product precursor (C1) (colorless transparent liquid). The trimethylsilyl group concentration that increased due to the reaction can be determined by NMR measurements of the trimethylsilylated product of the cured product precursor (C1). The Si—OH group concentration in the cured product precursor (C1) was determined to be 0.47 mol with respect to 1 mol of the 3-acryloyloxypropyltrimethoxysilane monomer (see Table 2).

### 1-3 Preparation of Curable Composition

0.12 g of 2-hydroxy-2-methyl-1-phenylpropan-1-one (radical photoinitiator) was added to 4 g of the cured product precursor (C1) to prepare a curable composition (B1).

### 1-4 Evaluation of Cured Product

A cured product was prepared in the manner described above using the curable composition (B1), and the thermal shock resistance, pencil hardness, and external appearance of the cured product were evaluated by the above methods.

### Example 2

A cured product precursor (C2) was obtained in the same manner as those in Example 1, except that 70.91 g (303 mmol) of 3-acryloyloxypropyltrimethoxysilane, 81.07 g (674 mmol) of dimethoxydimethylsilane, 45.22 g of 2-propanol, and 40.99 g of a 0.8% hydrochloric acid aqueous solution were used. The yield of the cured product precursor (C2) was 95.44 g. The cured product precursor (C2) had a viscosity of 207 mPa·s (25° C.) and a number average molecular weight of 1,300. The Si—OH group concentration in the cured product precursor (C2) was determined in the same manner as that in Example 1. The results are shown in Table 2.

After that, a cured product was produced in the same manner as those in Example 1 and evaluation of the thermal shock resistance, pencil hardness and external appearance were conducted.

### Example 3

Example 3 is a production example in which post-steps were performed.

The residual Si—OH groups included in the cured product precursor (C1) were trimethylsilylated in the same manner as described in Section “1-2 Measurement of residual Si—OH group concentration” in Example 1 to obtain a cured product precursor (C3).

A four-necked flask (200 mL) equipped with a three-one motor (stirrer), a dropping funnel, a reflux condenser, and a thermometer was charged with 30 mL of pyridine. 19 mL (150 mmol) of trimethylchlorosilane was then added dropwise to the flask using the dropping funnel (at room temperature) to obtain a pyridine solution of trimethylchlorosilane. Separately, a recovery flask (100 mL) was charged with 20.00 g of the cured product precursor (C1) synthesized in Example 1, and 30 mL of pyridine was added to the flask to dissolve the cured product precursor (C1) to obtain a pyridine solution of the cured product precursor (C1). The pyridine solution of the cured product precursor (C1) was added dropwise to the pyridine solution of trimethylchlorosilane at room temperature using the dropping funnel, and the mixture was stirred at a temperature of 75° C. for 3 hours. After the addition of 3 g of water to the reaction mixture, 0.002 g of the polymerization inhibitor was added to the mixture, and the solvent was evaporated under reduced pressure to concentrate the mixture. Subsequently 50.00 g of diisopropyl ether was added to dissolve the residue, 20.00 g of water was added to the solution, and a washing operation was performed using a separating funnel. The washing operation was repeated seven times in total. After the addition of 0.002 g of the polymerization inhibitor to dissolve the organic layer, the solvent was evaporated under reduced pressure to obtain the cured product precursor (C3) (i.e., a trimethylsilylated product of the cured product precursor (C1)) (colorless transparent liquid). The yield of the cured product precursor (C3) was 9.34 g. The cured product precursor (C3) had a viscosity of 336 mPa·s (25° C.) and a number average molecular weight of 1,400.

After that, a cured product was produced in the same manner as those in Example 1 and evaluation of the thermal shock resistance, pencil hardness and external appearance were conducted. Since the cured product precursor (C3) of Example 3 was obtained by reacting the M monomer with the Si—OH groups included in the cured product precursor (C1), the amount of M unit is shown in parentheses in Table 2. The amount (19 mL) of trimethylchlorosilane with respect to 20.0 g of the cured product precursor (C1) corresponds to 761 mmol based on the total amount of the cured product precursor (C1), and is large excess with respect to residual Si—OH in the cured product precursor (C1). However, since only trimethylchlorosilane equivalent to Si—OH included in the cured product precursor (C1) remains in the cured product precursor (C3) as the M unit, the Si—OH content in the cured product precursor (C3) is 0.

### Example 4

A cured product precursor (C4) was obtained in the same manner as those in Example 1, except that 56.73 g (242 mmol) of 3-acryloyloxypropyltrimethoxysilane, 16.21 g (135 mmol) of dimethoxydimethylsilane, 9.43 g (58 mmol) of hexamethyldisiloxane, 33.55 g of 2-propanol, 19.15 g of a 0.8% hydrochloric acid aqueous solution, and 0.01 g of p-methoxyphenol were used instead of 113.46 g (484 mmol) of 3-acryloyloxypropyltrimethoxysilane, 32.43 g (270 mmol) of dimethoxydimethylsilane, 45.19 g of 2-propanol, 36.19 g of a 0.8% hydrochloric acid aqueous solution, and 0.02 g of p-methoxyphenol, and that the reaction temperature was set to room temperature. The yield of the cured product precursor (C4) was 57.90 g. The cured product precursor (C4) had a viscosity of 207 mPa·s (25° C.) and a number average molecular weight of 1,000. The Si—OH group concentration in the cured product precursor (C4) was determined in the same manner as that in Example 1. The results are shown in Table 2. Note that one hexamethyldisiloxane molecule forms two M units through copolycondensation.

After that, a cured product was produced in the same manner as those in Example 1 and evaluation of the thermal shock resistance, pencil hardness and external appearance were conducted.

### Example 5

A cured product precursor (C5) was obtained in the same manner as those in Example 1, except that 62.09 g (250 mmol) of 3-methacryloyloxypropyltrimethoxysilane, 60.11 g (500 mmol) of dimethoxydimethylsilane, 38.06 g (250 mmol) of tetramethoxysilane, 60.10 g of 2-propanol, 49.95 g of a 0.8% hydrochloric acid aqueous solution, and 0.02 g of p-methoxyphenol were used instead of 113.46 g (484 mmol) of 3-acryloyloxypropyltrimethoxysilane, 32.43 g (270 mmol) of dimethoxydimethylsilane, 45.19 g of 2-propanol, 36.19 g of a 0.8% hydrochloric acid aqueous solution, and 0.02 g of p-methoxyphenol. The yield of the cured product precursor (C5) was 97.60 g. The cured product precursor (C5) had a viscosity of 28,900 mPa·s (25° C.) and a number average molecular weight of 2,500. The Si—OH group concentration in the cured product precursor (C5) was determined in the same manner as that in Example 1. The results are shown in Table 2. The amount of T unit is shown in parentheses in Table 1 since 3-methacryloyloxypropyltrimethoxysilane was used as the T monomer in Example 5 instead of 3-acryloyloxypropyltrimethoxysilane.

After that, a cured product was produced in the same manner as those in Example 1 and evaluation of the thermal shock resistance, pencil hardness and external appearance were conducted.

### Example 6

A cured product precursor (C6) was obtained in the same manner as those in Example 1, except that 141.82 g (605 mmol) of 3-acryloyloxypropyltrimethoxysilane, 162.13 g (1.349 mmol) of dimethoxydimethylsilane, 8.13 g (60.5 mmol) of tetramethyldisiloxane, 88.86 g of 2-propanol, 83.08 g of a 0.8% hydrochloric acid aqueous solution, and 0.04 g of p-methoxyphenol were used instead of 113.46 g (484 mmol) of 3-acryloyloxypropyltrimethoxysilane, 32.43 g (270 mmol) of dimethoxydimethylsilane, 45.19 g of 2-propanol, 36.19 g of a 0.8% hydrochloric acid aqueous solution, and 0.02 g of p-methoxyphenol, and that the reaction temperature was set to room temperature. The yield of the cured product precursor (C6) was 198.6 g. The cured product precursor (C6) had a viscosity of 115 mPa·s (25° C.) and a number average molecular weight of 1,360. The Si—OH group concentration in the cured product precursor (C6) was determined in the same manner as that in Example 1. The results are shown in Table 2. Note that one tetramethyldisiloxane molecule forms two M units through copolycondensation. In Example 6, since tetramethyldisiloxane was used instead of hexamethyldisiloxane (see Table 1), H(Me)₂-Si—O— was produced as the M unit. In Table 2, the amount of M unit is shown in parentheses in order to indicate the presence of an Si—H bond.

After that, a cured product was produced in the same manner as those in Example 1 and evaluation of the thermal shock resistance, pencil hardness and external appearance were conducted.

### Comparative Example 1

A cured product precursor (C7) was obtained in the same manner as those in Example 1, except that 70.30 g (300 mmol) of 3-acryloyloxypropyltrimethoxysilane, 26.01 g of 2-propanol, 16.35 g of a 0.8% hydrochloric acid aqueous solution, and 0.01 g of p-methoxyphenol were used instead of 113.46 g (484 mmol) of 3-acryloyloxypropyltrimethoxysilane, 32.43 g (270 mmol) of dimethoxydimethylsilane, 45.19 g of 2-propanol, 36.19 g of a 0.8% hydrochloric acid aqueous solution, and 0.02 g of p-methoxyphenol. The yield of the cured product precursor (C7) was 50.56 g. The cured product precursor (C7) had a viscosity of 5,570 mPa·s (25° C.) and a number average molecular weight of 1,500. The Si—OH group concentration in the cured product precursor (C7) was determined in the same manner as that in Example 1. The results are shown in Table 2.

After that, a cured product was produced in the same manner as those in Example 1 and evaluation of the thermal shock resistance, pencil hardness and external appearance were conducted.

### Comparative Example 2

A cured product precursor (C8) was obtained in the same manner as those in Example 1, except that 100.85 g (430 mmol) of 3-acryloyloxypropyltrimethoxysilane, 76.74 g (430 mmol) of triethoxymethylsilane, 53.28 g of 2-propanol, and 46.91 g of a 0.8% hydrochloric acid aqueous solution were used instead of 113.46 g (484 mmol) of 3-acryloyloxypropyltrimethoxysilane, 32.43 g (270 mmol) of dimethoxydimethylsilane, 45.19 g of 2-propanol, and 36.19 g of a 0.8% hydrochloric acid aqueous solution. The yield of the cured product precursor (C8) was 101.40 g. The cured product precursor (C8) had a viscosity of more than 20,000 mPa·s (25° C.) and a number average molecular weight of 1,400. The Si—OH group concentration in the cured product precursor (C8) was determined in the same manner as that in Example 1. The results are shown in Table 2.

After that, a cured product was produced in the same manner as those in Example 1 and evaluation of the thermal shock resistance, pencil hardness and external appearance were conducted.

### Comparative Example 3

A cured product precursor (C9) was obtained in the same manner as those in Example 1, except that 48.94 g (209 mmol) of 3-acryloyloxypropyltrimethoxysilane, 18.62 g (104 mmol) of triethoxymethylsilane, 8.48 g (52 mmol) of hexamethyldisiloxane, 44.83 g of 2-propanol, 18.02 g of a 0.8% hydrochloric acid aqueous solution, and 0.01 g of p-methoxyphenol were used instead of 113.46 g (484 mmol) of 3-acryloyloxypropyltrimethoxysilane, 32.43 g (270 mmol) of dimethoxydimethylsilane, 45.19 g of 2-propanol, 36.19 g of a 0.8% hydrochloric acid aqueous solution, and 0.02 g of p-methoxyphenol, and that the reaction temperature was set to room temperature. The yield of the cured product precursor (C9) was 50.81 g. The cured product precursor (C9) had a viscosity of 792 mPa·s (25° C.) and a number average molecular weight of 1,000. The Si—OH group concentration in the cured product precursor (C9) was determined in the same manner as that in Example 1. The results are shown in Table 2.

After that, a cured product was produced in the same manner as those in Example 1 and evaluation of the thermal shock resistance, pencil hardness and external appearance were conducted.

### Comparative Example 4

A four-necked flask (500 mL) equipped with a three-one motor (stirrer), a dropping funnel, a reflux condenser, and a thermometer was charged with 124.80 g (533 mmol) of 3-acryloyloxypropyltrimethoxysilane, 22.00 g of silanol-modified (each terminal) dimethyl silicone “X-21-5841” (functional group equivalent: 500 g/mol) manufactured by Shin-Etsu Chemical Co., Ltd., and 190.57 g of 2-propanol. After the dropwise addition of 10.07 g of a 4.8% tetramethylammonium hydroxide aqueous solution at room temperature, the mixture was stirred for 1 hour. 19.18 g of water was then added dropwise, and the mixture was stirred for 4 hours, followed by the addition of 5.49 g of a 5% sulfuric acid aqueous solution. After the addition of 0.02 g of p-methoxyphenol and dissolution, the solvent was evaporated under reduced pressure while blowing air into the mixture. After the addition of 176.00 g of diisopropyl ether and dissolution, 118.00 g of water was added to the solution, and a washing operation was performed using a separating funnel. The above operation was repeated seven times in total. After the addition of 0.03 g of p-methoxyphenol to the organic layer and dissolution, the solvent was evaporated under reduced pressure while blowing air into the mixture to obtain a cured product precursor (C10) (colorless transparent liquid). The yield of the cured product precursor (C10) was 103.40 g. The cured product precursor (C10) had a viscosity of 5,440 mPa·s (25° C.) and a number average molecular weight of 3,000. The Si—OH group concentration in the cured product precursor (C10) was determined in the same manner as that in Example 1. The results are shown in Table 2.

In Comparative Example 4, the silanol-modified (each terminal) dimethyl silicone was used instead of the D monomer. Since dimethyl silicone is a condensate of the D monomer, it is desirable to adjust the number of moles of silicon atoms included in dimethyl silicone corresponding to Example 1 instead of the number of moles of dimethyl silicone in order to compare the effects of copolycondensation of the D monomer in the condensation step with the effects of addition of the condensed D monomer. Therefore, the number of moles of silicon atoms included in dimethyl silicone with respect to 3-acryloyloxypropyltrimethoxysilane was adjusted to 1:0.56 in the same manner as in Example 1. In Table 2, the amount (0.56) of D unit is shown in parentheses.

After that, a cured product was produced in the same manner as those in Example 1 and evaluation of the thermal shock resistance, pencil hardness and external appearance were conducted.

### Comparative Example 5

A four-necked flask (500 mL) equipped with a three-one motor (stirrer), a dropping funnel, a reflux condenser, and a thermometer was charged with 113.46 g (484 mmol) of 3-acryloyloxypropyltrimethoxysilane, 32.43 g (270 mmol) of dimethoxydimethylsilane, and 45.19 g of 2-propanol. After the dropwise addition of 36.34 g of a 1.2% tetramethylammonium hydroxide aqueous solution at room temperature, the mixture was stirred for 5 hours, followed by the addition of 4.93 g of a 5% sulfuric acid aqueous solution. After the addition of 0.01 g of p-methoxyphenol and dissolution, the solvent was evaporated under reduced pressure while blowing air into the mixture. After the addition of 160.00 g of diisopropyl ether and dissolution, 100.00 g of water was added to the solution, and a washing operation was performed using a separating funnel. The above operation was repeated seven times in total. After the addition of 0.01 g of p-methoxyphenol to the organic layer and dissolution, the solvent was evaporated under reduced pressure while blowing air into the mixture to obtain a cured product precursor (C11) (colorless transparent liquid). The yield of the cured product precursor (C11) was 94.30 g. The cured product precursor (C11) had a viscosity of 13,000 mPa·s (25° C.) and a number average molecular weight of 3,300. The Si—OH group concentration in the cured product precursor (C11) was determined in the same manner as that in Example 1. The results are shown in Table 2.

After that, a cured product was produced in the same manner as those in Example 1 and evaluation of the thermal shock resistance, pencil hardness and external appearance were conducted.

Table 1 shows the monomer composition (raw materials) used to produce the cured product precursor in Examples 1 to 6 and Comparative Examples 1 to 5, the copolycondensation catalyst, and the value “w/(a+x+y+2c)” (i.e., the relationship between the amount of each monomer).

TABLE 1

| | | Example | | | | | | Comparative Example | | | | |
|---|---|---|---|---|---|---|---|---|---|---|---|---|
| Raw materials, etc. | | 1 | 2 | 3 | 4 | 5 | 6 | 1 | 2 | 3 | 4 | 5 |
| Q monomer (a) | Tetramethoxysilane (mmol) | | | | | 250 | | | | | | |
| T monomer (w) | 3-Acryloyloxypropyltrimethoxysilane (mmol) | 484 | 303 | 484 | 242 | | 605 | 300 | 430 | 209 | 533 | 484 |
| | 3-Methacryloyloxypropyltrimethoxysilane | | | | | 250 | | | | | | |
| | (mmol) | | | | | | | | | | | |
| | Triethoxymethylsilane (mmol) | | | | | | | | 430 | 104 | | |
| D monomer (x) | Dimethoxydimethylsilane (mmol) | 270 | 674 | 270 | 135 | 500 | 1349 | | | | | 270 |
| M monomer (y) | Trimethylchlorosilane (mmol) | | | 0 | | | | | | | | |
| M2 monomer (c) | Hexamethyldisiloxane (mmol) | | | | 58 | | | | | 52 | | |
| | Tetramethyldisiloxane (mmol) | | | | | | 60.5 | | | | | |
| End-capping step | Trimethylchlorosilane (mmol) | | | 761 | | | | | | | | |

| Catalyst used for condensation | HCl | | | | | | HCl | | | TMAH | |
|---|---|---|---|---|---|---|---|---|---|---|---|
| w/(a + x + y + 2c) | 1.8 | 0.4 | 1.8 | 1.0 | 0.3 | 0.4 | — | — | 3.0 | — | 1.8 |

In Table 1, TMAH (catalyst used for condensation) refers to tetramethylammonium hydroxide.

Table 2 shows the ratio of each unit in the cured product precursor represented by the following general formula (8), and the value “z/(a+w+x+y+2c)” (i.e., the relationship between the amount of Si—OH groups and the amount of each monomer in the cured product precursor (condensate)).

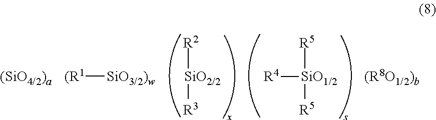

The value “z/(a+w+x+y+2c)” was calculated using the following method. The cured product precursor from which the organic solvent, water, and the acid catalyst had been removed by concentration was dissolved in pyridine to prepare a pyridine solution. This pyridine solution containing the cured product precursor was charged with a pyridine solution of trimethylchlorosilane having a specific concentration to effect a reaction, and then unreacted trimethylchlorosilane was hydrolyzed and removed by distillation. The trimethylsilyl group concentration in the cured product precursor that had increased due to the reaction was determined by ¹H-NMR to determine the residual Si—OH group concentration.

TABLE 2

| | Unit | | | | | | | |
|---|---|---|---|---|---|---|---|---|
| | Q unit | T unit | | D unit | M unit | (R⁸O_{1/2}) | Si—OH group | |
| | Molar ratio | | | | | | concentration | |
| | a | w | | x | s (y + 2c) | b | in condensate z | z/(a + w + x + y + 2c) |
| Example 1 | | 1.00 | | 0.56 | | 0.50 | 0.47 | 0.30 |
| Example 2 | | 1.00 | | 2.23 | | 0.27 | 0.25 | 0.08 |
| Example 3 | | 1.00 | | 0.56 | (0.47) | 0.03 | 0.00 | 0.00 |
| Example 4 | | 1.00 | | 0.56 | 0.43 | 0.50 | 0.45 | 0.23 |
| Example 5 | 1.00 | (1.00) | | 2.00 | | 0.53 | 0.50 | 0.25 |
| Example 6 | | 1.00 | | 2.07 | (0.15) | 0.26 | 0.23 | 0.08 |
| Comparative | | 1.00 | | | | 0.63 | 0.60 | 0.60 |
| Example 1 | | | | | | | | |
| Comparative | | 1.00 | 1.00 | | | 0.60 | 0.57 | 0.29 |
| Example 2 | | | | | | | | |
| Comparative | | 1.00 | 0.50 | | 0.49 | 0.53 | 0.49 | 0.25 |
| Example 3 | | | | | | | | |
| Comparative | | 1.00 | | (0.56) | | 0.11 | 0.10 | 0.23 |
| Example 4 | | | | | | | | |
| Comparative | | 1.00 | | 0.56 | | 0.11 | 0.10 | 0.06 |
| Example 5 | | | | | | | | |

In Examples 1 to 6 and Comparative Examples 1 to 5, the Si—OH group concentration was high when using the acid catalyst, and was very low when using the basic catalyst (e.g., TMAH). The Si—OH group concentration in the condensate of Example 3 was the same as that of Example 1. However, since the cured product precursor of Example 3 was obtained by reacting the condensate synthesized in the presence of the HCl catalyst with TMCS in pyridine, the cured product precursor of Example 3 did not include an Si—OH group that reacts with TMCS (i.e., the Si—OH group concentration was 0). In Example 3, the end-capping step using TMCS was performed between the condensation step and the curing step.

Table 3 shows the thermal shock resistance test results obtained using the cured products of Examples 1 to 6 and Comparative Examples 1 to 5.

TABLE 3

| | Thermal shock resistance test results (260° C., 30 sec) | | | | | | | | | | |
|---|---|---|---|---|---|---|---|---|---|---|---|
| | (number of cured products that showed cracks or separation/total number of cured products) | | | | | | | | | | |
| | Before | 1st | | | | | | | | | |
| | heating | cycle | 2nd cycle | 3rd cycle | 4th cycle | 5th cycle | 6th cycle | 7th cycle | 8th cycle | 9th cycle | 10th cycle |
| Example 1 | 0/3 | 0/3 | 0/3 | 0/3 | 1/3 | 1/3 | 1/3 | 1/3 | 1/3 | 1/3 | 1/3 |
| Example 2 | 0/3 | 0/3 | 0/3 | 0/3 | 0/3 | 0/3 | 0/3 | 0/3 | 0/3 | 0/3 | 0/3 |
| Example 3 | 0/3 | 1/3 | 1/3 | 1/3 | 1/3 | 1/3 | 1/3 | 1/3 | 1/3 | 1/3 | 1/3 |
| Example 4 | 0/3 | 0/3 | 0/3 | 0/3 | 0/3 | 0/3 | 0/3 | 0/3 | 0/3 | 0/3 | 0/3 |
| Example 5 | 0/3 | 0/3 | 0/3 | 2/3 | 2/3 | 2/3 | 2/3 | 2/3 | 2/3 | 2/3 | 2/3 |
| Example 6 | 0/3 | 0/3 | 0/3 | 0/3 | 0/3 | 0/3 | 0/3 | 0/3 | 0/3 | 0/3 | 0/3 |
| Comparative | 1/3 | 2/3 | 2/3 | 2/3 | 2/3 | 2/3 | 2/3 | 3/3 | | | |
| Example 1 | | | | | | | | | | | |
| Comparative | 0/3 | 1/3 | 1/3 | 1/3 | 1/3 | 1/3 | 2/3 | 2/3 | 2/3 | 2/3 | 3/3 |
| Example 2 | | | | | | | | | | | |
| Comparative | 0/3 | 0/3 | 0/3 | 0/3 | 0/3 | 2/3 | 3/3 | | | | |
| Example 3 | | | | | | | | | | | |
| Comparative | 0/3 | 1/3 | 3/3 | | | | | | | | |
| Example 4 | | | | | | | | | | | |
| Comparative | 3/3 | | | | | | | | | | |
| Example 5 | | | | | | | | | | | |

In Comparative Example 1, cracks had occurred in one cured product among the three cured products before the thermal shock resistance test was performed. In Comparative Example 5, cracks had occurred in all of the three cured products before the thermal shock resistance test was performed. In Comparative Example 5, the same raw materials as those of Example 1 were used, but the basic copolycondensation catalyst was used. The Si—OH group concentration in the cured product precursor obtained in Comparative Example 5 significantly differed from that of Example 1. The pencil hardness of the cured products of Example 1 and Comparative Example 5 was 3H. However, the cured products of Example 1 and Comparative Example 5 significantly differed in the thermal shock resistance evaluation results. Specifically, the cured product of Example 1 had superiority over the cured product of Comparative Example 5.

Table 4 shows the pencil hardness and the external appearance evaluation results of the cured products of Examples 1 to 6 and Comparative Examples 1 to 5.

TABLE 4

| | | Evaluation of external |
|---|---|---|
| | Pencil hardness | appearance |
| Example 1 | 3H | 2 |
| Example 2 | H | 1 |
| Example 3 | H | 2 |
| Example 4 | 4B | 1 |
| Example 5 | 3H | 3 |
| Example 6 | H | 1 |
| Comparative Example 1 | 3H | 4 |
| Comparative Example 2 | 5H | 4 |
| Comparative Example 3 | HB | 4 |
| Comparative Example 4 | F | 4 |
| Comparative Example 5 | 3H | 4 |

Almost the same monomer composition was used in Examples 3 and 4. In Example 4, the entire M2 monomer was used in the condensation step. In Example 3, the M monomer and the M2 monomer were not used in the condensation step, and the M monomer was added in the end-capping step. As a result, the hardness of the cured product of Example 3 was significantly higher than that of Example 4. The reason therefor is considered to be as follows. Specifically, since the M monomer and the M2 monomer have a function of stopping extension of the condensed chain in the condensation step to reduce the molecular weight and the degree of crosslinking of the cured product precursor, the cured product tends to become soft. However, since the M monomer and the M2 monomer do not achieve the above function when added after the condensation step, a hard cured product can be obtained. It was confirmed that it is advantageous to obtain a cured product by performing the end-capping step and the curing step when high thermal shock resistance and high hardness are desired, and a cured product that exhibits high thermal shock resistance and high hardness can be obtained by such a method.

### INDUSTRIAL APPLICABILITY

Since the thermal shock-resistant cured product according to the present invention can protect a substrate without showing separation and cracks even when repeatedly subjected to thermal shock at a high temperature, the thermal shock-resistant cured product may suitably be used as a protective layer or an adhesive material used for electronic parts and electronic devices produced using a solder reflow process. The thermal shock-resistant cured product may also suitably be used for further applications in which thermal shock occurs (e.g., transportation machine, aerospace, food processing, and nuclear power generation).

1. A method for producing a thermal shock-resistant cured product, comprising:
condensing by subjecting a monomer of formula (1), a monomer of formula (2), a monomer of formula (3), a monomer of formula (4), and a monomer of formula (5) to copolycondensation in a ratio of a mol, w mol, x mol, y mol, and c mol, respectively, in the presence of an acid catalyst to obtain a cured product precursor; and
curing by subjecting at least some of ethylenically unsaturated bonds comprised in the cured product precursor to polymerization to cure the cured product precursor,
wherein w and x are each independently a positive number,
a, y, and c are each independently 0 or a positive number, and
a, w, x, y, and c satisfy a relationship “0<w/(a+x+y+2c)≦10”, 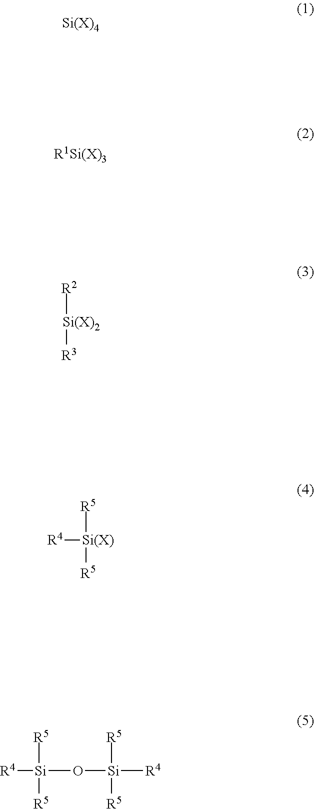
wherein (X) is a siloxane bond-forming group,
R¹, R², and R⁴ are each independently selected from the group consisting of a hydrogen atom, an alkyl group, an aralkyl group, a cycloalkyl group, a cycloaralkyl group, an aryl group, and a group having an ethylenically unsaturated bond, and
R³ and R⁵ are each independently selected from the group consisting of a hydrogen atom, an alkyl group, an aralkyl group, a cycloalkyl group, a cycloaralkyl group, and an aryl group, provided that at least one of R¹, R², and R⁴ is the group having an ethylenically unsaturated bond, and, when a plurality of (X) is present, some or all of the plurality of (X) are either identical or different.

2. The method according to claim 1,
wherein the cured product precursor comprises an Si—OH group in an amount of z mol, and a, w, x, y, c, and z satisfy a relationship of “0.1≦z/(a+w+x+y+2c)≦1.0”.

3. The method according to claim 1,
wherein the group having an ethylenically unsaturated bond is of formula (6), 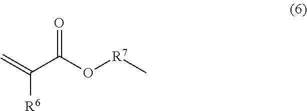
wherein R⁶ is a hydrogen atom or a methyl group, and R⁷ is an alkylene group having 1 to 6 carbon atoms.

4. The method according to claim 1,
wherein the monomer of formula (1) is present in an amount of 0 mol, and w, x, y, and c satisfy a relationship of “0.1≦w/(x+y+2c)≦2”.

5. The method according to claim 1, further comprising end-capping between the condensing and the curing by reacting at least one monomer selected from the group consisting of the monomer of formula (4) and the monomer of formula (5) with an Si—OH group.

6. A thermal shock-resistant cured product, obtained by the method according to claim 1.

7. The method according to claim 1,
wherein the monomer of formula (1) is a compound selected from the group consisting of tetramethoxysilane, tetraethoxysilane, tetra-n-propoxysilane, and tetra-n-butoxysilane.

8. The method according to claim 1,
wherein the monomer of formula (2) is a compound selected from the group consisting of (3-methacryloyloxypropyl)trimethoxysilane, (3-methacryloyloxypropyl)triethoxysilane, (3-acryloyloxypropyl)trimethoxysilane, and (3-acryloyloxypropyl)triethoxysilane.

9. The method according to claim 1,
wherein the monomer of formula (3) is a compound selected from the group consisting of dimethoxydimethylsilane, dimethoxydiethylsilane, diethoxydimethylsilane, diethoxydiethylsilane, dimethoxymethylphenylsilane, diethoxymethyphenyllsilane, and dimethoxybenzylmethylsilane.

10. The method according to claim 1,
wherein the monomer of formula (4) is a compound selected from the group consisting of methoxytrimethylsilane, methoxytriethylsilane, ethoxytrimethylsilane, ethoxtriethylsilane, methoxydimethylphenylsilane, ethoxydimethylphenylsilane, trimthylchlorosilane, triethylchlorosilane, trimethylbromosilane, and triethylbromosilane.

11. The method according to claim 1,
wherein the monomer of formula (5) is a compound selected from the group consisting of 1,1,3,3-tetramethyldisiloxane, 1,1,3,3-tetraethyldisiloxane, hexamethyldisiloxane, hexaethyldisiloxane, and hexapropyldisiloxane.

12. The method according to claim 5,
wherein the cured product precursor comprises an Si—OH group in an amount of z mol, and a, w, x, y, c, and z satisfy a relationship of “0.1≦z/(a+w+x+y+2c)≦1.0”.

13. The method according to claim 5,
wherein the group having an ethylenically unsaturated bond is of formula (6), 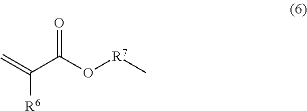
wherein R⁶ is a hydrogen atom or a methyl group, and R⁷ is an alkylene group having 1 to 6 carbon atoms.
